(19) United States
(12) Patent Application Publication
(10) Pub. No.: US 2025/0150149 A1
(43) Pub. Date: May 8, 2025

(54) METHOD AND APPARATUS FOR BEAM MANAGEMENT IN OPEN RADIO ACCESS NETWORKS

(71) Applicant: ELECTRONICS AND TELECOMMUNICATIONS RESEARCH INSTITUTE, Daejeon (KR)

(72) Inventor: Minhyun KIM, Daejeon (KR)

(73) Assignee: ELECTRONICS AND TELECOMMUNICATIONS RESEARCH INSTITUTE, Daejeon (KR)

(21) Appl. No.: 18/937,724

(22) Filed: Nov. 5, 2024

(30) Foreign Application Priority Data
Nov. 6, 2023 (KR) 10-2023-0151970
Oct. 31, 2024 (KR) 10-2024-0152897

(51) Int. Cl. H04B 7/06

(52) U.S. Cl. CPC H04B 7/06952

(57) ABSTRACT

A method of a near-real time controller may comprise: receiving, from a non-real time controller, information on an offline-trained artificial intelligence/machine learning (AI/ML) model; obtaining, from a base station, first data for beam management inference based on the offline-trained AI/ML model; performing beam management inference based on the offline-trained AI/ML model using the first data; and providing a control and policy according to a result of performing the beam management inference to the base station.

### CROSS-REFERENCE TO RELATED APPLICATIONS

This application claims priority to Korean Patent Applications No. 10-2023-0151970, filed on Nov. 6, 2023, and No. 10-2024-0152897, filed on Oct. 31, 2024, with the Korean Intellectual Property Office (KIPO), the entire contents of which are hereby incorporated by reference.

### BACKGROUND

### 1. Technical Field

The present disclosure relates to a beam management technique in an open radio access network (O-RAN), and more particularly, to a beam management technique in an O-RAN, which facilitates beam management based on artificial intelligence/machine learning (AI/ML).

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Information and communication technology has steadily advanced and evolved to accommodate various technological developments, now gradually moving toward 5G and 6G. Networks need to evolve accordingly to handle these changes and transition from traditional closed networks to open networks. The Open Radio Access Network (O-RAN) technology, which meets these demands, offers a more open radio access network architecture than what is currently provided by telecommunications companies. The open radio access network integrates artificial intelligence/machine learning (AI/ML) technologies into a RAN intelligent controller (RIC) and may require AI/ML-assisted procedures and definition of related interfaces for specific scenarios, such as beam management.

### SUMMARY

The present disclosure for resolving the above-described problems is directed to providing a method and an apparatus for beam management in an open radio access network (O-RAN), which facilitates beam management based on artificial intelligence/machine learning (AI/ML).

A method of a near-real time controller in an open radio access network, according to a first exemplary embodiment of the present disclosure, may comprise: receiving, from a non-real time controller, information on an offline-trained artificial intelligence/machine learning (AI/ML) model; obtaining, from a base station, first data for beam management inference based on the offline-trained AI/ML model; performing beam management inference based on the offline-trained AI/ML model using the first data; and providing a control and policy according to a result of performing the beam management inference to the base station.

The obtaining of the first data may comprise: requesting the first data for the beam management inference from the base station; receiving a first signal including the first data from the base station; and obtaining the first data from the first signal.

The method may further comprise: obtaining, from the base station, second data for evaluating a performance of the beam management inference based on the offline-trained AI/ML model; and evaluating the performance of the beam management inference base on the offline-trained AI/ML model using the second data.

The method may further comprise: obtaining, from the base station, third data for online training of the offline-trained AI/ML model; and performing online training of the offline-trained AI/ML model using the third data.

The providing of the control and policy may comprise: generating the control and policy according to the result of performing the beam management inference; and providing the control and policy to the base station.

A method of a base station in an open radio access network, according to a second exemplary embodiment of the present disclosure, may comprise: receiving a capability report request from a beam management device; transmitting a capability report including capability information of the base station to the beam management device according to the capability report request; receiving, from the beam management device, a transmission request for first data for offline training of an artificial intelligence/machine learning (AI/ML) model; transmitting the first data to the beam management device according to the transmission request for the first data; receiving information on a trained AI/ML model from the beam management device; and performing beam management based on the trained AI/ML model.

The method may further comprise: receiving, from the beam management device, a transmission request for second data for beam management inference based on the trained AI/ML model; transmitting the second data for beam management inference to the beam management device; and receiving, from the beam management device, a control and policy according to a result of the beam management inference using the second data, wherein the base station performs the beam management according to the control and policy.

The method may further comprise: receiving, from the beam management device, a control and policy for beam management inference using the trained AI/ML model; collecting third data for the beam management inference; and performing the beam management inference based on the AI/ML model using the third data, and performing the beam management according to a result of the beam management inference.

The method may further comprise: receiving, from the beam management device, a transmission request for fourth data for evaluating a performance of beam management inference based on the trained AI/ML model; and transmitting the fourth data to the beam management device.

The method may further comprise: collecting fifth data for evaluating a performance of beam management inference based on the trained AI/ML model; and evaluating the performance of the beam management inference based on the trained AI/ML model using the collected fifth data.

The method may further comprise: receiving a transmission request for sixth data for online training of the trained AI/ML model from the beam management device; and transmitting the sixth data to the beam management device.

The method may further comprise: collecting seventh data for online training of the trained AI/ML model; and performing online training of the trained AI/ML model using the seventh data.

A base station in an open radio access network, according to a third exemplary embodiment of the present disclosure, may comprise at least one processor, and the processor may cause the base station to perform: receiving a capability report request from a beam management device; transmitting a capability report including capability information of the base station to the beam management device according to the capability report request; receiving, from the beam management device, a transmission request for first data for offline training of an artificial intelligence/machine learning (AI/ML) model; transmitting the first data to the beam management device according to the transmission request for the first data; receiving information on a trained AI/ML model from the beam management device; and performing beam management based on the trained AI/ML model.

The at least one processor may further cause the base station to perform: receiving, from the beam management device, a transmission request for second data for beam management inference based on the trained AI/ML model; transmitting the second data for beam management inference to the beam management device; and receiving, from the beam management device, a control and policy according to a result of the beam management inference using the second data, wherein the base station performs the beam management according to the control and policy.

The at least one processor may further cause the base station to perform: receiving, from the beam management device, a control and policy for beam management inference using the trained AI/ML model; collecting third data for the beam management inference; and performing the beam management inference based on the AI/ML model using the third data, and performing the beam management according to a result of the beam management inference.

The at least one processor may further cause the base station to perform: collecting fourth data for evaluating a performance of beam management inference based on the trained AI/ML model; and evaluating the performance of the beam management inference based on the trained AI/ML model using the collected fourth data.

The at least one processor may further cause the base station to perform: collecting fifth data for online training of the trained AI/ML model; and performing online training of the trained AI/ML model using the fifth data.

According to the present disclosure, a non-real time RAN intelligent controller (RIC) of an O-RAN can perform offline training of an AI.ML model. A near-real time RIC of the O-RAN can perform online training of the AI/ML model. Additionally, the near-real time RIC can utilize the AI/ML model to perform inference for beam management.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of an open radio access network.

FIGS. 4A and 4B are conceptual diagrams illustrating a first exemplary embodiment of a non-real time RIC in an open radio access network.

FIG. 5 is a conceptual diagram illustrating a first exemplary embodiment of a near-real time RIC of an open radio access network.

FIG. 6 is a conceptual diagram illustrating a first exemplary embodiment of a beam management device.

FIG. 7 is a conceptual diagram illustrating a second exemplary embodiment of a beam management device.

FIG. 8 is a conceptual diagram illustrating a third exemplary embodiment of a beam management device.

FIG. 9 is a conceptual diagram illustrating a fourth exemplary embodiment of a beam management device.

FIG. 10 is a conceptual diagram illustrating a first exemplary embodiment of a performance monitoring and online training process.

FIG. 11 is a conceptual diagram illustrating a second exemplary embodiment of the performance monitoring and online training process.

FIG. 12 is a sequence chart illustrating a first exemplary embodiment of a beam management method in an open radio access network.

FIG. 13 is a sequence chart illustrating a second exemplary embodiment of a beam management method in an open radio access network.

FIG. 14 is a sequence chart illustrating a third exemplary embodiment of a beam management method in an open radio access network.

FIG. 15 is a sequence chart illustrating a fourth exemplary embodiment of a beam management method in an open radio access network.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

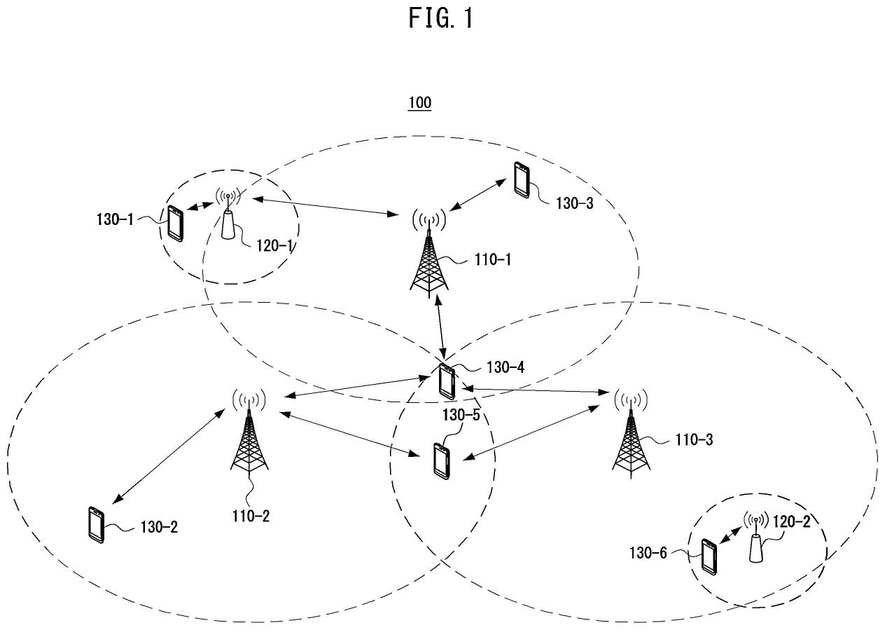

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

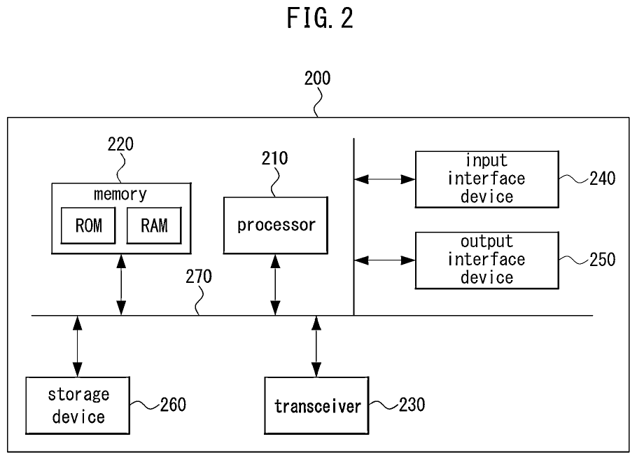

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

As mobile services such as social networking, video streaming, and online gaming continue to evolve, the advanced mobile communication networks beyond LTE need to meet technical requirements not only for high data transmission speeds but also to support a wider range of service scenarios. The International Telecommunication Union (ITU)-R has defined key performance indicators (KPIs) and requirements for International Mobile Telecommunications (IMT)-2020, the official name for 5G mobile communications. These can be summarized as enhanced mobile broadband (eMBB) for high data transmission speeds, ultra-reliable low latency communication (URLLC) for reduced latency, and massive machine-type communication (mMTC) for large-scale device connectivity.

The 3rd Generation Partnership Project (3GPP), an international standard development organization for mobile communications, has been developing 5G standard specifications based on new radio access technologies that meet the IMT-2020 requirements. In 5G, significant changes are being made to enable automation and intelligence in network operation, administration, and management, such as introducing Software-Defined Networking (SDN) and Network Function Virtualization (NFV) concepts into a core network. However, a radio access network (RAN), which includes base stations, remains a closed structure, dependent on protocols and interfaces of specific equipment manufacturers. This may lead to interoperability issues between equipments from different manufacturers and hinder market entry for various vendors.

In February 2018, five global telecommunications operators, AT&T, China Mobile, Deutsche Telekom, NTT DOCOMO, and Orange, took the initiative to establish the Open Radio Access Network (O-RAN) alliance. The O-RAN alliance aims to reshape RAN industry into more intelligent, open, virtualized, and fully interoperable mobile communication networks. Comprising over 300 members, including telecommunications operators, enterprises, and research institutions, the O-RAN Alliance is actively working on standardization and development of open-source platforms to promote the development of open and intelligent RAN for the 5G era and beyond, towards 6G.

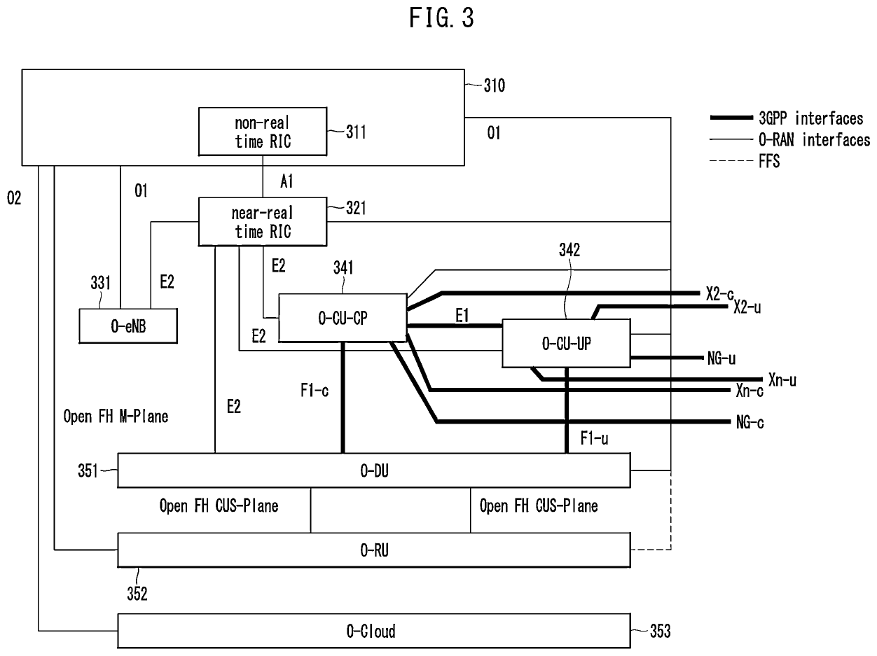

The O-RAN that the O-RAN alliance aims to realize fundamentally refers to an open radio access network in the literal sense, encompassing all technologies that enable interoperability between base station equipments from different manufacturers. Therefore, the O-RAN can specifically include both hardware (HW) and software (SW) components that constitute the RAN, as well as standardized interfaces between these components. To implement an open and intelligent radio access network, the O-RAN alliance has designed and standardized the O-RAN architecture, as illustrated in FIG. 3 below.

FIG. 3 is a conceptual diagram illustrating a first exemplary embodiment of an open radio access network.

Referring to FIG. 3, in an open radio access network, a service management and orchestration framework (SMO) 310 may include a non-real time RAN intelligent controller (RIC) 311 therein. The SMO 310 may be referred to as an open RAN management unit. The non-real time RIC may be referred to as a non-real time controller.

The SMO 310 may be connected to a near-real time RIC 321, an open (O)-eNB 331, an open (O)-central unit (CU)-control plane (CP) 341, an O-CU-user plane (UP) 342, and an O-distributed unit (DU) 351 through O1 interfaces. In addition, the SMO 310 may be connected to an O-radio unit (RU) 352 through an open fronthaul management plane (open FH M-Plane) interface, and may be connected to an O-Cloud 353 through an O2 interface.

The near-real time RIC 321 may be connected to the O-eNB 331, the O-CU-CP 341, the O-CU-UP 342, and the O-DU 351 through E2 interfaces. In addition, the near-real time RIC 321 may be connected to the non-real time RIC 311 through an A1 interface. The O-CU-CP 341 may be connected to the O-CU-UP 342 through an E1 interface, and to the O-DU 351 through an F1-c interface. In addition, the O-CU-CP 341 may be connected to other nodes of the 3GPP network through X2-c interfaces, Xn-c interfaces, and NG-c interfaces. Here, the near-real time RIC may be referred to as a near-real time controller.

The O-CU-UP 342 may be connected to the O-DU 351 through an F1-u interface. In addition, the O-CU-UP 342 may be connected to other nodes of the 3GPP network through an X2-u interface, Xn-u interface, and NG-u interface.

The O-DU 351 may be connected to the O-RU 352 through an open fronthaul control, user and synchronization (CUS)-plane (open FH CUS-Plane) interface and an open FH M-Plane interface.

The non-real time RIC 311 included in the SMO 310 may be a logical function block, and may perform non-real time control on RAN elements and resources through detailed data collection through the E2 interfaces. More specifically, the non-real time RIC 311 may manage the network configuration as a whole through detailed data collection, and may provide recommendations to the near-real time RIC 321 by fetching AI-based feeds. The non-real time RIC 311 may provide policy, enrichment information, and ML model management information to the near-real time RIC 321 through the A1 interface. In addition, the non-real time RIC 311 may receive policy feedbacks from the near-real time RIC 321 through the A1 interface.

The near-real time RIC 321 may be a logical function block. The near-real time RIC 321 may perform near-real time control, optimize RAN elements and resources, and perform AI/ML workflows including model training and updates. The near-real time RIC 321 may provide policy-based guidance for applications within the near-real time RIC 321. The near-real time RIC 321 may control the RAN using xApps. The near-real time RIC 321 may enable near-real time optimization control on RAN elements (referred to as E2 nodes) through tasks transmitted through the E2 interfaces, which are open interfaces. The near-real time RIC 321 may transmit RIC control and policies to and from the RAN elements through the E2 interfaces, and receive feedbacks thereon.

The xApp is an abbreviation for extended application (xApp), and may be an independent software application for a third party to provide functional extensibility to the RAN, which operates within the near-real time RIC 321. The xApp may control operations such as handover optimization, radio link monitoring, radio resource management, mobility management, load balancing, slicing policy updates, traffic coordination, interference management, and security. In other words, a first xApp may be an application for optimizing handover, and a second xApp may be an application for radio link monitoring. In the above-described manner, various types of xApps that operate within the near-real time RIC 321 may be introduced.

The O-eNB 331 may refer to a 3rd generation (3G) base station and/or 4th generation (4G) base station that can access the SMO 310 of O-RAN. In addition, the O-eNB 331 may be connected to the near-real time RIC 321 through the E2 interface. Therefore, the O-eNB 331 may be controlled by the xApps loaded on the near-real time RIC 321 or may provide information requested by the xApps loaded on the near-real time RIC 321 by feeding back the information. Other operations may be the same as those of the 3G base station and/or 4G base station.

The O-CU-CP 341 may be an O-RAN CU-CP according to specifications of the O-RAN alliance. The O-CU-CP 341 may be a logical node hosting a radio resource control (RRC) and a control plane portion of a packet data convergence protocol (PDCP). The O-CU-UP 342 may be a logical node hosting a user plane portion of the PDCP and a service data adaptation protocol (SDAP), which is an O-CU-UP according to specifications of the O-RAN alliance.

The O-DU may be a logical node based on split of lower layer functions of the O-CU (including the O-CU-CP 341 and O-CU-UP 342) and may be a logical node hosting radio link control (RLC) layer, medium access control (MAC) layer and high-physical (PHY) layer. The O-RU 352 may be a logical node hosting low-PHY layer and RF processing based on split of lower layer functions. The O-Cloud 353 may be a set of hardware and software that provides cloud computing for hosting and executing O-RAN network functions.

As described above, the O-RAN architecture basically defines the ability to configure a virtualized RAN on open hardware, and defines interfaces standardized in accordance with 3GPP and related mobile communication standards to realize an open and highly compatible supply ecosystem. In addition, the O-RAN has introduced the RIC for AI/ML-assisted RAN control. The RIC can be divided into the non-real time RIC and the near-real time RIC based on their control delay times and main functions.

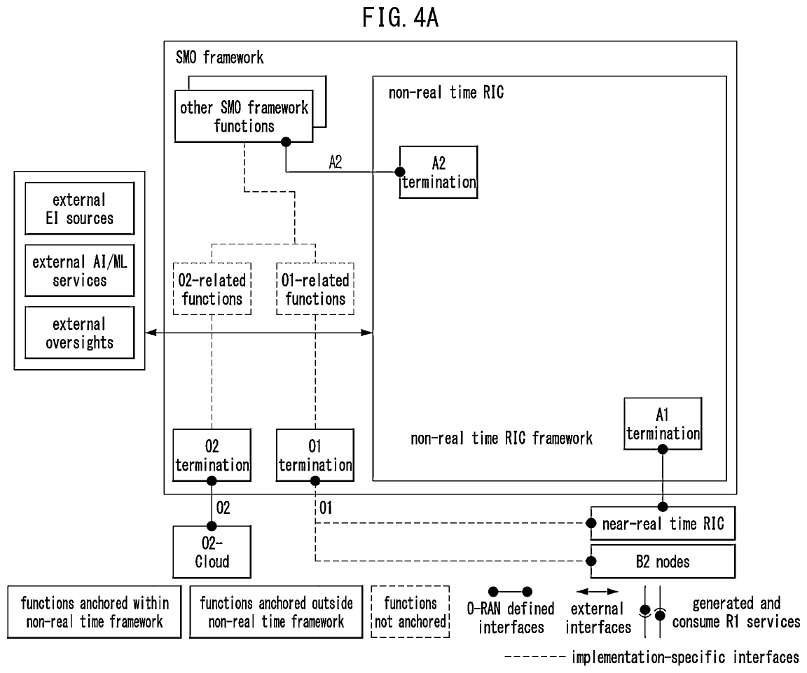

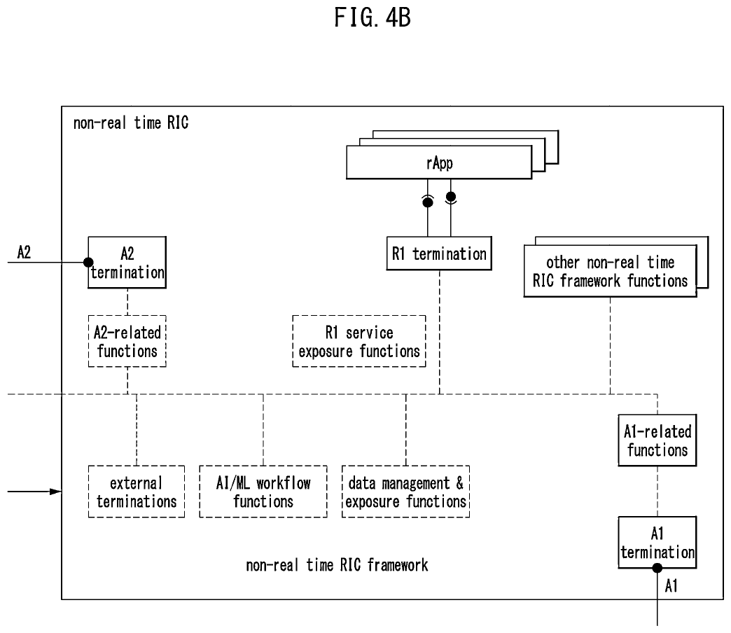

FIGS. 4A and 4B are conceptual diagrams illustrating a first exemplary embodiment of a non-real time RIC in an open radio access network.

Referring to FIG. 4, a non-real time RIC framework (or platform) and rApps hosted by the near-real time RIC are illustrated for R1 interfaces within the SMO framework system architecture and the O1, O2, and A1 interfaces within the O-RAN. The non-real time RIC may represent a subset of functions of the SMO framework. The non-real time RIC may have access to other SMO framework functions, thereby influencing what is carried over the O1 and O2 interfaces (e.g. configuration management (CM) and/or performance management (PM)).

The non-real time RIC may include a non-real time (non-RT) framework. The non-real time RIC framework may include, among other functions, R1 service exposure functions that process R1 services provided according to exemplary embodiments. The non-real time RIC functions within the non-real time RIC framework may support authorization, authentication, registration, discovery, communication support, etc. for rApps.

Non-real time RIC applications (rApps) may be applications that utilize functions available in the non-real time RIC framework and/or the SMO framework to provide value-added services related to RAN operation and optimization. The scope of rApps may include, but is not limited to, radio resource management, data analysis, and information enrichment.

To this end, the non-real time RIC framework may generate and/or consume R1 services according to exemplary embodiments through the R1 interfaces. The R1 interfaces may be terminated at an R1 termination of the non-real time RIC framework. The R1 termination may connect to the non-real time RIC framework and rApps through the R1 interfaces, and allow the non-real time RIC framework and rApps to exchange messages/data (i.e. requests and responses including data models) to access the R1 services through the R1 interfaces.

In addition, the non-real time RIC framework includes A1-related functions. The A1-related functions of the non-real time RIC framework may support, for example, A1 logical termination, A1-policy orchestration and cataloging, A1-EI orchestration and cataloging, and the like. Data management and exposure services within the non-real time RIC framework may deliver data generated or collected by data producers to data consumers according to their needs.

The non-real time RIC framework may further include external terminations. The external terminations may support, for example, data exchange between the non-real time RIC framework and external AI/ML functions, enrichment information sources (EI sources), or external oversights. Within the non-real time RIC framework, AI/ML workflow services may provide access to AI/ML workflows. For example, the AI/ML workflow services may support monitoring AI/ML models deployed on the non-real time RIC, training the models, and the like.

In addition, the non-real time RIC framework may include A2-related functions supporting A2 logical termination, A2-policy coordination and cataloging, and the like. Within the non-real time RIC framework, the R1 interfaces may be open logical interfaces within the O-RAN architecture between rApps and the non-real time RIC framework of the non-real time RIC. The R1 interfaces may support exchange of control signaling information and collection and transfer of data between endpoints. The R1 interfaces may enable, for example, multi-vendor rApps to consume and/or produce R1 services. The R1 interfaces may be independent of the specific implementations of the SMO and the non-real time RIC framework of the non-real time RIC. The R1 interfaces may be defined in an extensible manner, allowing new services and data types to be added without having to change the protocols or procedures.

In particular, the R1 interfaces may facilitate interconnection between rApps and non-real time RIC frameworks supplied by different vendors. To this end, the R1 interfaces may provide a level of abstraction between the rApps and the non-real time RIC framework and/or the SMO framework. The non-real time RIC framework may also facilitate interconnection between rApps and O2 endpoints through O2-related functions of the SMO framework. The O2 endpoint may be connected to the O2 interface. The O2 interface may be an open logical interface within the O-RAN architecture. The logical functions that generate O2-related services to the rApps through the R1 interfaces may be referred to as O2-related functions.

The O2-related functions may, among other functions, realize at least one of the following functions: providing O2-related services to rApps through the R1 interfaces, interfacing with O-Cloud management services (e.g. infrastructure management services or deployment management services) through the O2 interface termination to obtain fault, configuration, accounting, performance and security (FCAPS) data from the O-Cloud management services, provisioning configuration changes to the O-Cloud, and performing conflict mitigation for configuration changes to the O-Cloud. In connection with interfacing with the O-Cloud management services, the O2-related functions receive O-cloud infrastructure FCAPS data from the O-Cloud. Additionally, the O2-related functions may receive O-Cloud deployment FCAPS data from the O-Cloud.

As described above, the non-real time RIC may be an internal function of the SMO block of the O-RAN architecture that provides the A1 interfaces to the near-real time RIC. The main function of the non-real time RIC may be to support intelligent RAN operation and optimization by issuing policy-based instructions to optimize RAN functions (e.g. intelligent radio resource management) with a processing time of 1 second or more, training/inferring AI/ML models, or providing enrichment information to the near-real time RIC through the A1 interfaces. The non-real time RIC may also serve as a platform on which rApps operate, providing all functions required for the rApps.

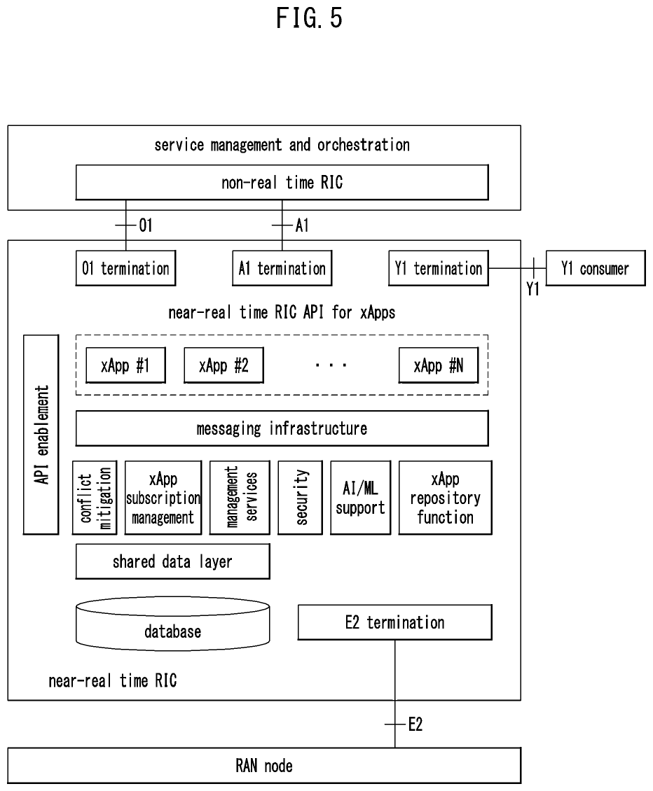

FIG. 5 is a conceptual diagram illustrating a first exemplary embodiment of a near-real time RIC of an open radio access network.

Referring to FIG. 5, the near-real time RIC may have the SMO positioned at the top and an RAN node (e.g. base station (gNB)) positioned at the bottom. The near-real time RIC may include the following functions and roles.
Shared data layer may be used to read, write, and modify information stored in a database.
Database may store status information of base stations and user equipments received through the E2 interfaces.
Conflict mitigation may resolve potentially overlapping or conflicting requests from multiple xApps.
xApp subscription management may perform subscription merging and integrated data distribution across different xApps.
Management services may act as service producers for the SMO. These services may include fault management, configuration management, and performance management.
Security may provide a security framework for xApps.
AI/ML support may perform tasks such as data pipelining, training, and performance monitoring for xApps.
xApp repository function may select xApps for A1 message routing based on A1 policy types and operator policies and perform access control for A1-Enrichment Information (EI) types according to policies.
Messaging infrastructure may support message interactions between the internal functions of the near-real time RIC.
Interface termination may connect with the O1, A1, Y1, and E2 interfaces and manage the termination of the respective interfaces. These terminations may include the O1 termination, A1 termination, Y1 termination, and E2 termination.
API enablement may support functions related to API operations of the near-real time RIC. These API operations may include API repository/registry, authentication, discovery, and general event subscription.

The near-real time RIC operates with control intervals ranging from 10 ms to 1 second and may provide near-real time services and radio resource management functions to the E2 nodes through data collection and actions through the E2 interfaces. The near-real time RIC may collect cell/terminal information from the E2 nodes using the E2 interface and host one or more xApps for specific purposes to control and optimize the services and resources of the E2 nodes in near-real time. Additionally, the control of the near-real time RIC may be adjusted according to policies and enrichment information provided through the Al interfaces. The near-real time RIC may also generate RAN analytics based on available data and expose this information through the Y1 interface.

Meanwhile, the E2 nodes may be defined as logical nodes connected to the E2 interfaces and may include the O-CU-CP, O-CU-UP, O-DU, and/or O-eNB. The O-CU may be a function block responsible for upper layers of a base station and may be divided into a control plane, O-CU-CP, which delivers control information, and a user plane, O-CU-UP, which handles traffic. Accordingly, the O-CU-CP may perform radio resource control (RRC) and a control part of the PDCP. The O-CU-UP may perform a user part of the PDCP and the SDAP. The O-DU may be a function block responsible for radio link control (RLC), medium access control (MAC), and a higher physical layer of the base station. The O-eNB may serve as an LTE base station. The primary targets in the E2 nodes may be typically the O-CU or O-DU.

The O-RU may be a function block responsible for a lower physical layer of the base station, and the role division with the higher physical layer in the O-DU may follow the functional split options standardized in the O-RAN alliance. Therefore, the O-RU may mainly perform radio signal processing. Unlike other function blocks in O-RAN, the O-RU may be implemented as a physical network function (PNF), may be installed, and may define an open fronthaul interface with the O-DU.

The present disclosure may relate to methods and procedures for implementing AI/ML-assisted beam management technology in scenarios involving massive multiple-input and multiple-output (MIMO) within the O-RAN architecture. The beam management technology proposed for cases involving massive MIMO, as defined by O-RAN working group (WG) 1 and related WGs, may align with the concept of beam management technology defined in the 3GPP NR.

The present disclosure may specifically propose a system architecture for the implementation of AI/ML-assisted beam management technology within the O-RAN architecture, roles of the respective entities within the system architecture, and an overall beam management procedure including AI/ML workflows that differ depending on the structure.

Before detailed description on the present disclosure, issues or limitations of conventional beam management methods will be described. Additionally, a brief explanation will be provided on the AI/ML-assisted beam management techniques that the 3GPP aims to introduce to overcome these challenges. The AI/ML-assisted beam management techniques that 3GPP aims to introduce are being actively studied in the RAN1, focusing on the necessary specifications for applying AI/ML technologies to beam management scenarios over the air interface, which serves as the background for the present disclosure.

One of the differences between the 5G NR and other 3GPP systems, such as Wideband Code Division Multiple Access (WCDMA) or LTE, is its use of a wide range of frequency bands to increase transmission capacity. In particular, millimeter-wave bands are considered one of the key enablers of 5G. However, high-frequency bands have poor diffraction and reflection characteristics, resulting in greater propagation losses, such as path losses and reflection losses, compared to low-frequency bands. Therefore, when the NR system operates in high-frequency bands, its cell coverage may be reduced compared to that of low-frequency bands.

To address these issues, the communication system may extend cell coverage in high-frequency bands through beamforming with multiple antennas. In this case, the communication system may involve frequent measurement and reporting of beam quality for all available beams from terminals to a base station to establish a high-quality transmission link through beamforming between the base station and each terminal. This process has been standardized as a beam management procedure within the 3GPP 5G NR standards. The beam management procedure plays a fundamentally important role in maintaining a good link between the base station and the terminal, especially in millimeter-wave communication.

Such beam management procedure may have significant limitations. In other words, achieving precise beam alignment between the base station and the terminal may be very challenging and may require substantial costs. From the terminal's perspective, frequent beam quality measurements, computations, and reporting to the base station may consume a lot of power. From the base station's perspective, beam management for each terminal requires dedicated resources, and performing beam management periodically for all terminals in the network may consume a large amount of overall resources.

However, without frequent beam measurements and reporting, the connection between the base station and the terminal may be easily interrupted due to the movement of highly mobile terminals or blockages caused by obstacles. Therefore, balancing network performance improvements with signaling overhead in beam management is of utmost importance.

Various solutions have been proposed to address the aforementioned issues. Among them, approaches utilizing AI/ML technologies, which have been actively applied in many other fields, have been suggested as solutions to these challenges. The 3GPP has started standardization efforts for applying AI/ML technologies to the physical layer starting with Release 18, prioritizing beam management as a key area of research. The AI/ML-assisted beam management under study in the 3GPP focuses on beam prediction in the time or spatial domain to reduce overhead and latency, as well as improving the accuracy of beam selection.

The O-RAN is structurally incorporating AI/ML technologies into the RIC and has prioritized their application for scenarios involving massive MIMO within WG1. Accordingly, it may require the definition of AI/ML-assisted procedures and related interfaces for specific scenarios like beam management. Additionally, since the O-RAN aims to ensure interoperability with the 3GPP standards, it may take into account the direction of AI/ML technology adoption in the 3GPP. Considering these needs and directions, the AI/ML-assisted beam management architecture and procedures within the O-RAN structure may be defined as follows.

### AI/ML-Assisted Beam Management Architecture

The AI/ML-assisted beam management architecture may have various forms depending on where training and inference of the AI/ML models are performed. The various architectures proposed in the present disclosure are not intended merely to increase structural diversity but rather arise from the fact that the functional scope is determined by the characteristics of the respective entities. Since the necessary deployment may vary depending on the environments and conditions, possible architectures are proposed accordingly. Before detailing the architectures, several assumptions for their configuration may be outlined as follows.

First, the training of AI/ML models within the overall architecture may be divided into two stages: offline training, which is performed initially and over long-term cycles, and online training, which involves re-training over short-term cycles. In addition, performance monitoring may be performed by various entities, with a primary purpose assumed to be supporting online training. Accordingly, to facilitate online training following performance monitoring, an entity responsible for performance monitoring may be configured as the same entity that conducts the online training.

Additionally, beam management App(s) may be executed on either the non-real time RIC or the near-real time RIC to enable effective beam management within the network. As defined in the O-RAN specifications, operations with a control latency of over 1 second may be performed as rApps on the non-real time RIC, while operations with a control latency between 10 ms and 1 second may be executed as xApps on the near-real time RIC. The implementation may vary depending on the operational goals of the telecommunications operator, and thus, the present disclosure does not restrict a specific form of the architecture.

For convenience in preparing exemplary embodiments, the beam management process is deemed more suitable for a control timing of the near-real time RIC, and therefore, exemplary embodiments will be described considering the beam management xApp. However, the possibility of beam management rApp operation is not excluded, and it is expected to function similarly to exemplary embodiments described below. The beam management xApp may be configured with performance goals related to beam management that the telecommunications operator intends to achieve, playing a role in generating E2 control and policy actions aligned with the set objectives.

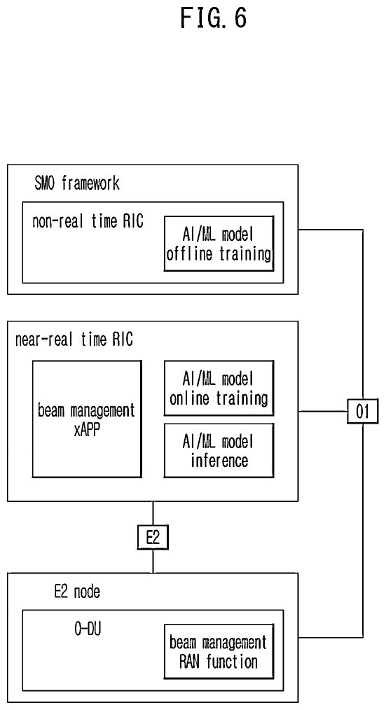

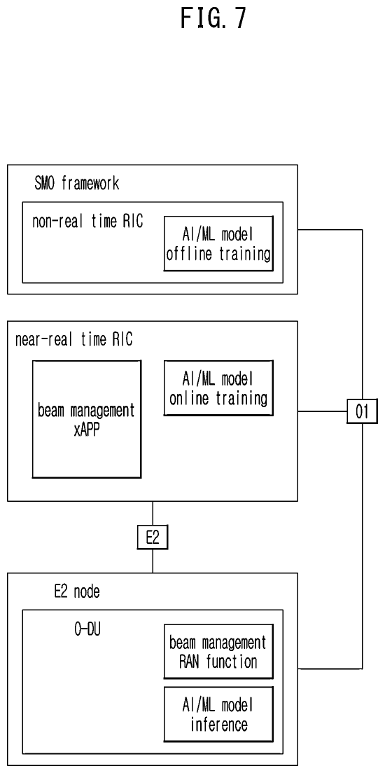

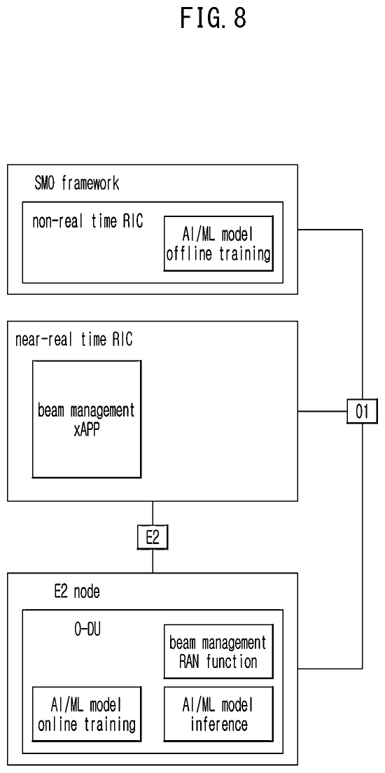

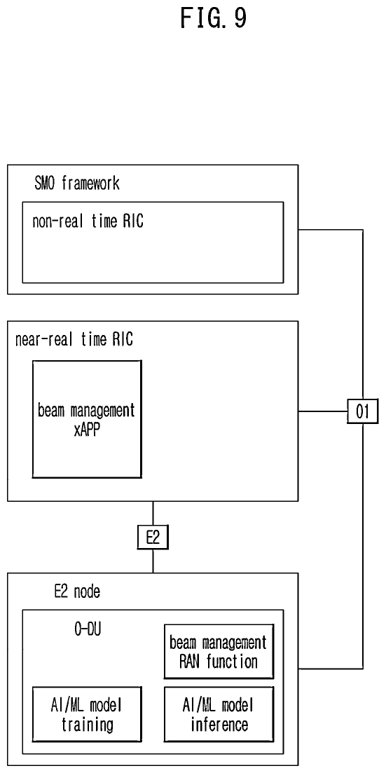

The AI/ML-assisted beam management architecture may be primarily categorized based on an entity responsible for performing AI/ML model inference. For example, if the near-real time RIC performs the AI/ML model inference, the architecture may follow Structure 1 (refer to FIG. 6). On the other hand, if the E2 node (O-DU) performs the AI/ML model inference, the architecture may follow Structure 2 (refer to FIG. 7), Structure 3 (refer to FIG. 8), or Structure 4 (refer to FIG. 9).

The AI/ML-assisted beam management architecture may be further categorized based on entities responsible for performing offline and online training of the AI/ML model when model inference is carried out at the E2 node. For example, depending on the entities responsible for offline and online training of the AI/ML model, the AI/ML-assisted beam management architecture may be categorized into Structure 2, Structure 3, or Structure 4. The specific characteristics of the respective structures are as follows.

FIG. 6 is a conceptual diagram illustrating a first exemplary embodiment of a beam management device.

Referring to FIG. 6, in a beam management device, offline training of the AI/ML model may be performed in the non-real time RIC, and online training and inference of the AI/ML model may be performed in the near-real time RIC. Finally, an RAN function for beam management may be performed in the E2 node. Such structure of the beam management device may be referred to as a first structure of beam management. The beam management device of the first structure may be similar to a structure typically presented in the O-RAN standards. Therefore, the near-real time RIC may generate an E2 control and policy (control & policy) according to an objective configured by a beam management xApp in conjunction with an inference result of the AI/ML model, and indicate the generated E2 control and policy to the E2 node. Then, the E2 node may receive the indication from the near-real time RIC and perform beam management functions based on the received message.

FIG. 7 is a conceptual diagram illustrating a second exemplary embodiment of a beam management device.

Referring to FIG. 7, in a beam management device, offline training of the AI/ML model may be performed in the non-real time RIC, and online training of the AI/ML model may be performed in the near-real time RIC. Finally, inference of the AI/ML model and an RAN function for beam management may be performed in the E2 node. Such structure of the beam management device may be referred to as a second structure of beam management. The beam management device may perform training of complex AI/ML models in the RIC by considering a computational capability of the RIC that is higher than that of the E2 node. In this case, the beam management device may distribute offline and online trainings to the non-real time and near-real time RICs by considering control delay times. The beam management device may allow the E2 node to perform relatively simple AI/ML model inference by transferring the trained AI/ML model to the E2 node.

The beam management device may allow the E2 node to directly link an inference result of the AI/ML model inference and the beam management function. This may have the advantage of making the beam management function less affected by a capacity and latency of the E2 interface. However, conversely, additional instructions may be required so that the E2 control and policy from the xApp are linked to the inference result of the AI/ML inference in the E2 node so that the beam management function can be performed as intended at the near-real time RIC.

FIG. 8 is a conceptual diagram illustrating a third exemplary embodiment of a beam management device.

Referring to FIG. 8, in a beam management device, offline training of the AI/ML model may be performed in the non-real time RIC. In addition, inference of the AI/ML model, beam management RAN function, and online training of the AI/ML model may be performed in the E2 node. Such structure of the beam management device may be referred to as a third structure of beam management. The beam management device may delegate offline training of very heavy AI/ML models to the SMO and non-real time RIC with large resources. The beam management device may process core functions related to beam management at the E2 node only when the capability of the E2 node is supported. The E2 node may lead online training, perform performance monitoring, and perform evaluation and judgment. Accordingly, the role of the E2 node may be very important.

FIG. 9 is a conceptual diagram illustrating a fourth exemplary embodiment of a beam management device.

Referring to FIG. 9, a beam management device may have a structure similar to the third structure of beam management, and the structure may be referred to as a fourth structure of beam management. Such beam management structure may be a structure that allows all AI/ML functions and beam management RAN functions to be performed in the E2 node. Here, the E2 node may be a base station model that performs AI/ML as stipulated by the 3GPP. The AI/ML function of the beam management device may refer to an AI/ML function directly related to beam management. Since the non-real time RIC and the real-time RIC are expressed with no AI/ML function blocks, and thus they may not perform AI/ML functions at all. The non-real time RIC and the real-time RIC may support the beam management of the E2 node or perform AI/ML functions for purposes other than beam management. Therefore, the fourth structure of beam management may procedurally specify a method for controlling the AI/ML-assisted beam management of the E2 node by the beam management xApp of the near-real time RIC. Alternatively, the fourth structure of the beam management may specify a method for supporting the AI/ML-assisted beam management of the E2 node by the non-real time RIC and near-real time RIC.

### AI/ML-Assisted Beam Management Method

The AI/ML-assisted beam management device may perform the AI/ML-assisted assisted management method. The beam management method may include an AI/ML capability reporting process, an offline training process, an inference process for beam management, performance monitoring and online training processes, and/or the like. A functional entity in each process may vary according to a beam management structure. Accordingly, detailed procedures may vary slightly.

### (1) AI/ML Capability Reporting Process

In the AI/ML capability reporting process, the SMO may obtain AI/ML-related capability information of the E2 node. The beam management device may initially perform the AI/ML capability reporting process in the entire AI/ML-assisted beam management method. The E2 node may report the following information to the SMO in the AI/ML capability report process.
Whether the E2 node supports AI/ML operations
Types and sizes of AI/ML models that the E2 node can support (amount of model parameters)
AI/ML computational complexity that the E2 node can accept
AI/ML-related functions that the E2 node can support (e.g. AI/ML model training, inference, update, performance monitoring, etc.)
Current status of the E2 node (whether there is an AI/ML model currently running, etc.)

In order to support this process in the O-RAN, the communication system may define contents of an AI/ML function capability report in the O1 interface specifications. According to the definition, the SMO may request a function capability report from the E2 node. Then, the E2 node may receive the function capability report request from the SMO and report the function capability to the SMO through the O1 interface according to the request.

The non-real time RIC may require the contents of the function capability report. Accordingly, an E2 service model (E2SM) for the AI/ML function capability report may also be defined. Alternatively, the E2 node may deliver the contents to the non-real time RIC during E2 setup. Therefore, the E2 node may add the contents of the AI/ML function capability report to an information exchange procedure required during E2 setup. The O-RAN may determine an AI/ML-assisted beam management structure to be actually used through the AI/ML function capability report process.

### (2) Offline Training Process

Offline training may be a process of selecting and training an AI/ML model related to beam management at a beginning of system deployment or at a long-term cycle. The offline training may require a very large amount of computation and may take a long time. Therefore, the O-RAN may perform offline training in the non-real time RIC considering the control delay time. The SMO may collect data for offline training from the E2 nodes through the O1 interfaces and deliver the collected data to the non-real time RIC. Then, the non-real time RIC may receive the data required for offline training from the SMO.

The 3GPP may allow a base station to perform initial training of the AI/ML model. In the structure of FIG. 9, the E2 node may perform offline training. The offline training process may include a process of transferring the trained AI/ML model to an entity that performs inference after completing the offline training. Here, as the data for AI/ML model training, information on beam-related measurements for a certain period of time may be used. For example, beam-related measurement information may be layer 1 (L1)-reference signal received powers (RSRPs) and beam indexes corresponding thereto. For data collection in the SMO, the communication system may define information to be collected in the O1 interface specifications.

### (3) Inference Process for Beam Management

The beam management device may control/instruct beam management to be performed in the E2 node through inference of the AI/ML model trained in the offline training process. To this end, data for inference of the AI/ML model may first be required. The data for inference of the AI/ML model may be the same type of data used for training the AI/ML model.

In other words, beam-related measurement information generated before a time when inference is required may be used as input data for inference of the AI/ML model. The E2 node may perform beam management operations using the inference results. The inference of the AI/ML model may be performed in the near-real time RIC. The beam-related measurement information, which is data required for inference of the AI/ML model, may be defined in the E2 interface specifications. The definition of E2 control and policy may also be reflected in E2 service model RAN control (E2SM-RC) specifications. In addition, the AI/ML model inference result may require definition of a linkage relationship with E2 control and policy.

### (4) Performance Monitoring and Online Training Process

The performance monitoring and online training process may be the last operation performed in the AI/ML-assisted beam management method. The performance monitoring may observe a performance of the network obtained as a result of the beam management function operations due to the inference results of the currently performed AI/ML model. The performance monitoring may be a core procedure of an AI/ML workflow to identify validity of the AI/ML model. In addition, the beam management device may determine whether to perform online training through the performance monitoring.

The online training may refer to re-training performed at a short-term cycle, and may be a model update process such as updating model parameter values. In this process, data collection may refer to collecting KPI-related data for performance monitoring and beam measurement information required for online training. The KPI-related data for performance monitoring may be composed of the following information. The KPI-related data for performance monitoring may be reflected in E2 service model key performance measurement (E2SM-KPM) specifications.
KPIs related to beam prediction accuracy (e.g. Top-K/1 beam prediction accuracy, etc.)
KPIs related to link quality (e.g. throughput, L1-RSRP, L1-signal to interference plus noise ratio (SINR), hypothetical block error rate (BLER), etc.)
Performance metric based on input/output data distribution of AI/ML
Difference value between predicted L1-RSRP and actual measured L1-RSRP

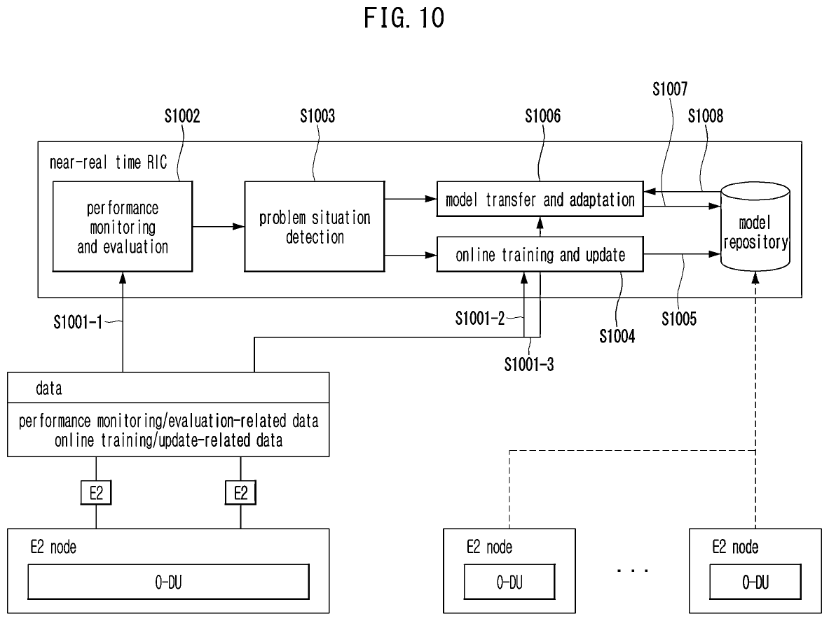

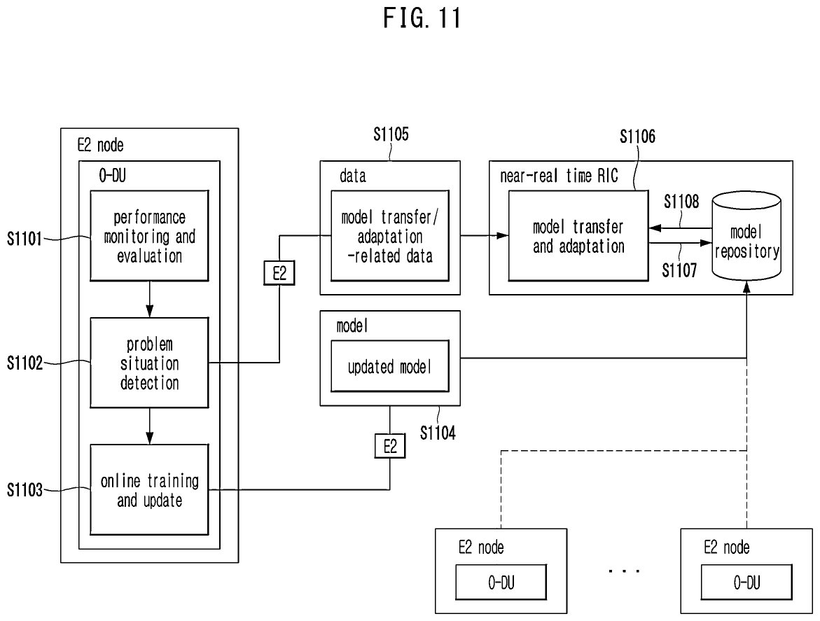

Additionally, the present disclosure proposes introducing a model transfer and adaptation process as a part of AI/ML model management during the performance monitoring process. In other words, a sudden performance degradation may occur during the performance monitoring, or a problem situation may be detected during the performance monitoring, such as continuously falling short of a performance target even with online training. The near-real time RIC may have a repository for managing AI/ML models of multiple base stations and may use a new AI/ML model derived by performing model transfer and adaptation. Alternatively, the near-real time RIC may transfer the new AI/ML model to the E2 node and recommend the E2 node to use the new AI/ML model. A case where the near-real time RIC performs performance monitoring (Structures 1 and 2) and a case where the E2 node performs performance monitoring (Structures 3 and 4) may be different. In such cases, the detailed procedures may be as shown in FIGS. 10 and 11 below.

FIG. 10 is a conceptual diagram illustrating a first exemplary embodiment of a performance monitoring and online training process.

Referring to FIG. 10, in the performance monitoring and online training process, the E2 node may transmit performance monitoring/evaluation-related data to the near-real time RIC (S1001-1). Then, the near-real time RIC may receive the performance monitoring/evaluation-related data from the E2 node. In addition, the E2 node may transmit data for online training and update to the near-real time RIC (S1001-2, S1001-3). Then, the near-real time RIC may receive the data for online training and update from the E2 node.

The near-real time RIC may perform performance monitoring and evaluation based on the performance monitoring/evaluation-related data received from the E2 node (S1002). Then, the near-real time RIC may attempt to detect a problem situation (S1003). Here, the problem situation may be a sudden performance deterioration, continuous failure to meet the performance target even with online training, or the like. If the near-real time RIC does not detect a problem situation, the near-real time RIC may perform online training and model update using data for online training (S1004). Then, the near-real time RIC may store the updated model in a model repository (S1005).

If the near-real time RIC does not detect a problem situation, the near-real time RIC may perform model transfer and adaptation using the received data for online training (S1006). In this case, the near-real time RIC may perform model transfer and adaptation using a model stored in the model repository (S1007, S1008).

FIG. 11 is a conceptual diagram illustrating a second exemplary embodiment of the performance monitoring and online training process.

Referring to FIG. 11, in the performance monitoring and online training process, the E2 node may collect performance monitoring/evaluation-related data. In addition, the E2 node may collect data for online training and update. The E2 node may perform performance monitoring and evaluation based on the collected performance monitoring/evaluation-related data (S1101). The E2 node may attempt to detect a problem situation (S1102). Here, the problem situation may be a sudden performance deterioration, continuous failure to meet a performance target even with online training, or the like. If the E2 node does not detect a problem situation, the E2 node may perform online training and model update using the collected data for online training (S1103). Then, the E2 node may store the updated model in the model repository (S1104). In this case, the E2 node may transmit the updated model to the near-real time RIC. Accordingly, the near-real time RIC may receive the updated model from the E2 node.

If the E2 node detects a problem situation, the E2 node may report the problem situation to the near-real time RIC. Accordingly, the near-real time RIC may receive and identify the problem situation from the E2 node. Alternatively, if model transfer and adaptation are required, the E2 node may request model transfer and adaptation to the near-real time RIC. The near-real time RIC may receive the model transfer and adaptation request from the E2 node. Then, the E2 node may transmit model transfer/adaptation-related data to the near-real time RIC (S1105). Then, the near-real time RIC may receive the model transfer/adaptation-related data from the E2 node. The near-real time RIC may perform model transfer and adaptation using a model stored in the model repository based on the received model transfer/adaptation-related data (S1106, S1107, S1108).

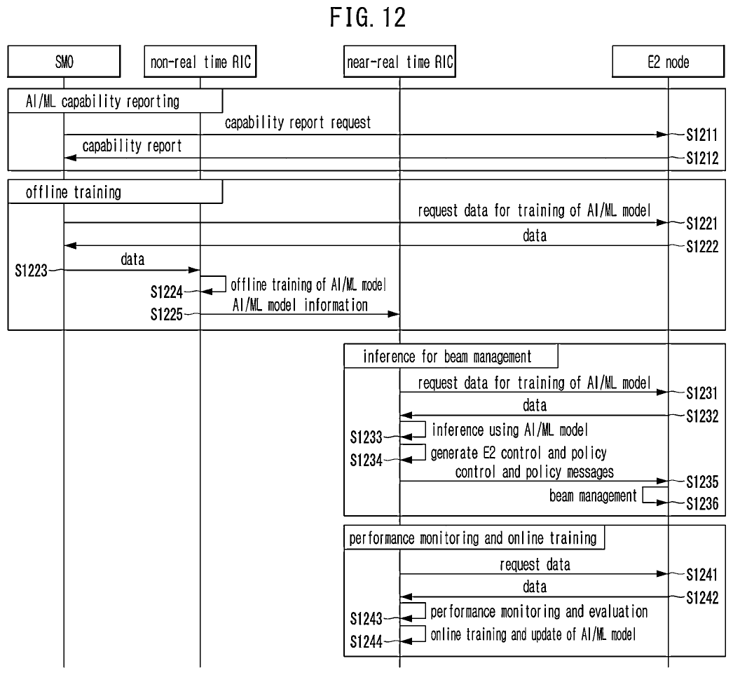

FIG. 12 is a sequence chart illustrating a first exemplary embodiment of a beam management method in an open radio access network.

Referring to FIG. 12, in the AI/ML capability reporting process, the SMO may request the E2 node to report E2 capability (S1211). Then, the E2 node may receive the E2 capability report request from the SMO. Then, the E2 node may report E2 capability to the SMO according to the request of the SMO (S1212). Accordingly, the SMO may receive the E2 capability report from the E2 node and identify capability of the E2 node.

Then, in the offline training process, the SMO may request data for training of the AI/ML model from the E2 node (S1221). Then, the E2 node may receive the request for data for training of the AI/ML model from the SMO. Then, the E2 node may collect data for training of the AI/ML model according to the request of the SMO and transmit the collected data to the SMO (S1222). The SMO may receive the data for training of the AI/ML model from the E2 node. Then, the SMO may deliver the data received from the E2 node to the non-real time RIC (S1223). The non-real time RIC may receive the data for training of the AI/ML model from the SMO and perform offline training of the AI/ML model (S1224). The non-real time RIC may transfer the offline-trained AI/ML model to the near-real time RIC (S1225). Then, the near-real time RIC may receive the offline-trained AI/ML model from the non-real time RIC and use the offline-trained AI/ML model for inference for beam management.

Then, in the inference process for beam management, the near-real time RIC may request data for inference for beam management using the AI/ML model to the E2 node (S1231). Then, the E2 node may receive the request for data for inference for beam management of the AI/ML model from the near-real time RIC. Then, the E2 node may collect data for inference of the AI/ML model according to the request of the near-real time RIC and transmit the collected data to the near-real time RIC (S1232). The near-real time RIC may receive the data for inference of the AI/ML model from the E2 node. The near-real time RIC may perform inference for beam management through the AI/ML model by utilizing the data received from the E2 node (S1233). The near-real time RIC may generate a control message or a policy message for beam management of the E2 node based on a result of the inference using the AI/ML model (S1234). The near-real time RIC may transmit the generated control message or policy message to the E2 node (S1235). Then, the E2 node may receive the control message or the policy message for beam management from the near-real time RIC. The E2 node may perform beam management according to control data of the received control message or a policy of the policy message (S1236).

Then, in the performance monitoring and online training process, the near-real time RIC may request the E2 node to transmit data for performance monitoring of the AI/ML model and data for online training of the AI/ML model (S1241). Then, the E2 node may collect data for performance monitoring of the AI/ML model and data for online training of the AI/ML model, and transmit the collected data to the near-real time RIC (S1242). The near-real time RIC may receive the data for performance monitoring of the AI/ML model from the E2 node. Then, the near-real time RIC may monitor the performance of the AI/ML model using the received data for performance monitoring and evaluate the performance of the AI/ML model (S1243). In addition, the near-real time RIC may receive the data for online training of the AI/ML model from the E2 node, perform online training of the AI/ML model using the received data, and update the AI/ML model (S1244).

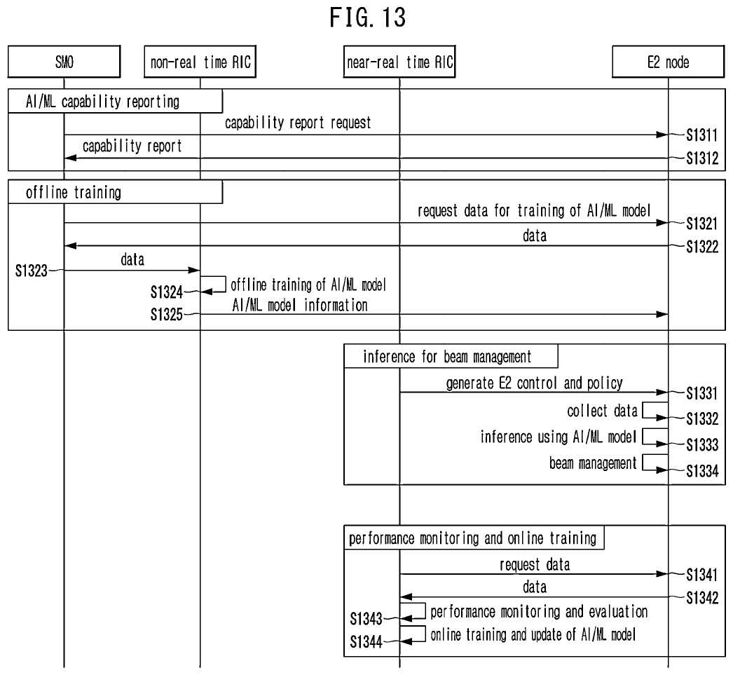

FIG. 13 is a sequence chart illustrating a second exemplary embodiment of a beam management method in an open radio access network.

Referring to FIG. 13, in the AI/ML capability reporting process, the SMO may request the E2 node to report E2 capability (S1311). Then, the E2 node may receive the E2 capability report request from the SMO. Then, the E2 node may report E2 capability to the SMO according to the request of the SMO (S1312). Accordingly, the SMO may receive the E2 capability report from the E2 node and identify capability of the E2 node.

Then, in the offline training process, the SMO may request data for training of the AI/ML model to the E2 node (S1321). Then, the E2 node may receive the request for data for training of the AI/ML model from the SMO. Then, the E2 node may collect data for training of the AI/ML model according to the request of the SMO and transmit the collected data to the SMO (S1322). The SMO may receive the data for training of the AI/ML model from the E2 node. Then, the SMO may deliver the data received from the E2 node to the non-real time RIC (S1323). The non-real time RIC may receive the data for training of the AI/ML model from the SMO, and perform offline training of the AI/ML model (S1324). The non-real time RIC may deliver information on the offline-trained AI/ML model to the E2 node (S1325). Then, the E2 node may receive the offline-trained AI/ML model from the non-real time RIC, and utilize the offline-trained AI/ML model for inference for beam management.

Then, in the inference process for beam management, the near-real time RIC may generate control data and a policy for beam management using the AI/ML model in the E2 node. Then, the near-real time RIC may transmit a control message including the control data and a policy message including the policy to the E2 node (S1331). The E2 node may receive the control message and policy message from the near-real time RIC. The E2 node may collect data for inference for beam management using the AI/ML model (S1332). Then, the E2 node may perform inference for beam management through the AI/ML model by utilizing the collected data for inference of the AI/ML model (S1333). The E2 node may perform beam management according to the control message or policy message for beam management of the E2 node based on a result of the inference of the AI/ML model (S1334).

Then, in the performance monitoring and online training process, the near-real time RIC may request transmission of data for performance monitoring of the AI/ML model and data for online training of the AI/ML model to the E2 node (S1341). Then, the E2 node may collect data for performance monitoring of the AI/ML model and data for online training of the AI/ML model, and transmit the collected data to the near-real time RIC (S1342). The near-real time RIC may receive the data for performance monitoring of the AI/ML model from the E2 node. In addition, the near-real time RIC may monitor the performance of the AI/ML model using the received data for performance monitoring and evaluate the performance of the AI/ML model (S1343). In addition, the near-real time RIC may receive the data for online training of the AI/ML model from the E2 node, perform online training of the AI/ML model using the received data, and update the AI/ML model (S1344).

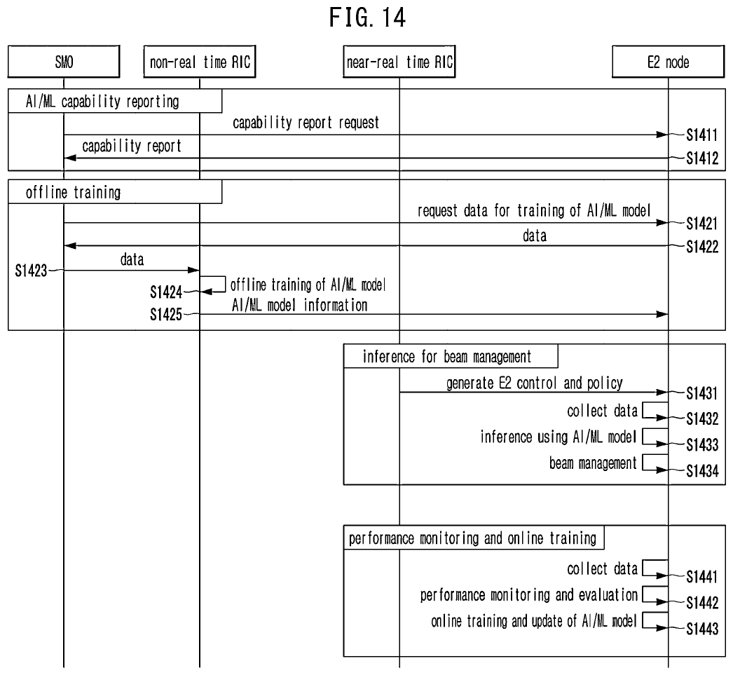

FIG. 14 is a sequence chart illustrating a third exemplary embodiment of a beam management method in an open radio access network.

Referring to FIG. 14, in the AI/ML capability reporting process, the SMO may request the E2 node to report E2 capability (S1411). Then, the E2 node may receive the E2 capability report request from the SMO. Then, the E2 node may report E2 capability to the SMO according to the request of the SMO (S1412). Accordingly, the SMO may receive the E2 capability report from the E2 node and identify capability of the E2 node.

Then, in the offline training process, the SMO may request data for training of the AI/ML model to the E2 node (S1421). Then, the E2 node may receive the request for data for training of the AI/ML model from the SMO. Then, the E2 node may collect data for training of the AI/ML model according to the request of the SMO and transmit the collected data to the SMO (S1422). The SMO may receive the data for training of the AI/ML model from the E2 node. Then, the SMO may deliver the data received from the E2 node to the non-real time RIC (S1423). The non-real time RIC may receive the data for training of the AI/ML model from the SMO, and perform offline training of the AI/ML model (S1424). The non-real time RIC may deliver information on the offline-trained AI/ML model to the E2 node (S1425). Then, the E2 node may receive the offline-trained AI/ML model from the non-real time RIC, and utilize the offline-trained AI/ML model for inference for beam management.

Then, in the inference process for beam management, the near-real time RIC may generate control data and a policy for beam management using the AI/ML model in the E2 node. Then, the near-real time RIC may transmit a control message including the control data and a policy message including the policy to the E2 node (S1431). The E2 node may receive the control message and policy message from the near-real time RIC. The E2 node may collect data for inference for beam management using the AI/ML model (S1432). Then, the E2 node may perform inference for beam management through the AI/ML model by utilizing the collected data for inference of the AI/ML model (S1433). The E2 node may perform beam management according to the control message or policy message for beam management of the E2 node based on a result of the inference using the AI/ML model (S1434).

Then, in the performance monitoring and online training process, the E2 node may collect data for performance monitoring of the AI/ML model and data for online training (S1441). The E2 node may monitor the performance of the AI/ML model using the collected data for performance monitoring to evaluate the performance of the AI/ML model (S1442). In addition, the E2 node may perform online training of the AI/ML model using the collected data for online training of the AI/ML model, and update the AI/ML model (S1443).

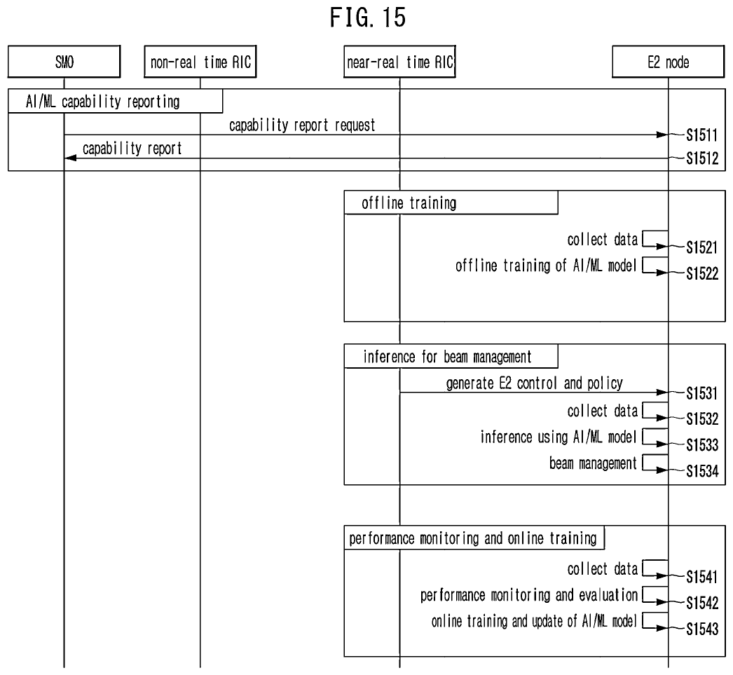

FIG. 15 is a sequence chart illustrating a fourth exemplary embodiment of a beam management method in an open radio access network.

Referring to FIG. 15, in the AI/ML capability reporting process, the SMO may request the E2 node to report E2 capability (S1511). Then, the E2 node may receive the E2 capability report request from the SMO. Then, the E2 node may report E2 capability to the SMO according to the request of the SMO (S1512). Accordingly, the SMO may receive the E2 capability report from the E2 node and identify capability of the E2 node.

Then, in the offline training process, the E2 node may collect data for training of the AI/ML model (S1521). The E2 node may perform offline training of the AI/ML model using the collected data for training the AI/ML model (S1522). The E2 node may utilize the offline-trained AI/ML model for inference for beam management.

Then, in the inference process for beam management, the near-real time RIC may generate control data and a policy for beam management using the AI/ML model in the E2 node. Then, the near-real time RIC may transmit a control message including the control data and a policy message including the policy to the E2 node (S1531). The E2 node may receive the control message and policy message from the near-real time RIC. The E2 node may collect data for inference for beam management of the AI/ML model (S1532). Then, the E2 node may perform inference for beam management through the AI/ML model by utilizing the collected data for inference of the AI/ML model (S1533). The E2 node may perform beam management according to the control message or policy message for beam management of the E2 node based on a result of the inference using the AI/ML model (S1534).

Then, in the performance monitoring and online training process, the E2 node may collect data for performance monitoring of the AI/ML model and data for online training of the AI/ML model (S1541). The E2 node may monitor the performance of the AI/ML model using the collected data for performance monitoring and evaluate the performance of the AI/ML model (S1542). In addition, the E2 node may perform online training of the AI/ML model using the collected data for online training of the AI/ML model and update the AI/ML model (S1543).

### Method for Monitoring and Evaluating Beam Management Performance in O-RAN

The performance monitoring and evaluation during beam management in the O-RAN may be performed in various manners. The terminal may transmit a measurement report to the E2 node. Then, the E2 node may receive the measurement report from the terminal. The E2 node may directly perform performance monitoring and evaluation. Alternatively, the E2 node may deliver the measurement report to the near-real time RIC. Then, the near-real time RIC may perform performance monitoring and evaluation by receiving the measurement report of the terminal, which is received from the E2 node. On the other hand, the terminal may directly measure the performance and thus perform performance monitoring and evaluation.

The performance monitoring and evaluation method performed in the network may be classified into a method of performing performance monitoring and evaluation in the near-real time RIC based on information reported from the terminal through the E2 node and a method of directly performing performance monitoring and evaluation in the E2 node. In addition, when the near-real time RIC performs performance monitoring and evaluation, the near-real time RIC may directly configure/instruct the relevant procedure to the E2 node, and request reporting of data for performance monitoring and evaluation purposes to the E2 node. The performance monitoring and evaluation procedure for each case may be as follows.

### (1) Performance Monitoring and Evaluation Method of the Near-Real Time RIC

The near-real time RIC may control all processes of performance monitoring and evaluation. In this case, the near-real time RIC may configure/instruct procedure(s) required for performing performance monitoring and evaluation to the E2 node. Accordingly, the E2 node may receive the configuration/instruction from the near-real time RIC, and the E2 node may configure/instruct measurement and reporting for performance monitoring to the terminal according to the configuration/instruction from the near-real time RIC. In other words, the E2 node may configure measurement signals and resources for performance measurement and reporting to the terminal.

### (1-1) First Exemplary Embodiment of Performance Monitoring and Evaluation Method of the Near-Real Time RIC

The terminal may perform performance measurement according to the configuration/instruction of measurement and reporting for performance monitoring from the E2 node. The terminal may perform performance calculation based on a result of the performance measurement and transmit a result of the performance calculation to the E2 node. The E2 node may receive the result of the performance calculation from the terminal. The E2 node may deliver the result of the performance calculation received from the terminal to the near-real time RIC. Then, the near-real time RIC may receive the result of the performance calculation from the E2 node.

### (1-2) Second Exemplary Embodiment of Performance Monitoring and Evaluation Method of the Near-Real Time RIC

The terminal may perform performance measurement according to the configuration/instruction of measurement and reporting for performance monitoring from the E2 node. The terminal may perform performance calculation based on a result of the performance measurement and derive an event (e.g. problem situation detection) based on a result of the performance calculation. The terminal may transmit the derived event to the E2 node. The E2 node may receive the event from the terminal. The E2 node may deliver the event received from the terminal to the near-real time RIC. Then, the near-real time RIC may receive the event from the E2 node.

### (1-3) Third Exemplary Embodiment of Performance Monitoring and Evaluation Method of the Near-Real Time RIC

The terminal may perform performance measurement according to the configuration/instruction of measurement and reporting for performance monitoring from the E2 node. The terminal may perform performance calculation based on a result of the performance measurement and transmit a result of the performance calculation to the E2 node. Alternatively, the E2 node may receive the result of the performance measurement from the terminal. The E2 node may perform performance calculation based on the result of the performance measurement and derive an event (e.g. problem situation detection) based on a result of the performance calculation. The E2 node may transmit the derived event to the near-real time RIC. Then, the near-real time RIC may receive the event from the E2 node.

### (1-4) Fourth Exemplary Embodiment of Performance Monitoring and Evaluation Method of the Near-Real Time RIC

The terminal may perform performance measurement according to the configuration/instruction of measurement and reporting for performance monitoring from the E2 node and report a result of the performance measurement to the E2 node. The E2 node may receive the result of the performance measurement from the terminal and deliver the received result of the performance measurement to the near-real time RIC. Accordingly, the near-real time RIC may receive the result of the performance measurement from the E2 node. The near-real time RIC may perform performance calculation to perform performance monitoring and evaluation. The near-real time RIC may transmit a result of the performance monitoring and evaluation to the E2 node. Alternatively, the near-real time RIC may transmit an event (e.g. problem situation detection) derived based on the result of the performance monitoring and evaluation to the E2 node.

Meanwhile, there may be several options in the performance calculation and evaluation process of the network and the performance measurement and calculation process of the terminal, and all the options that can be selected by the E2 node or the terminal may be initially defined within the configuration/instruction of the near-real time RIC.

The near-real time RIC may request the E2 node to report data for performance monitoring and evaluation. In this case, the near-real time RIC may perform performance monitoring and evaluation in the same manner as the procedure in FIG. 10. In contrast, the E2 node may not receive any configurations/instructions from the near-real time RIC. In this case, the E2 node may perform performance monitoring and evaluation on its own. In this case, if the E2 node is performing a data collection procedure for performance monitoring and evaluation, the E2 node may transmit the collected data directly. If the E2 node is not performing a data collection procedure, the E2 node may perform a data collection procedure.

### (2) Performance Monitoring and Evaluation Method of the E2 Node

The performance monitoring and evaluation performed on the E2 node may operate on its own criteria without instructions from the near-real time RIC. The E2 node may request notification/reporting permission from the near-real time RIC when necessary. Alternatively, the E2 node may receive a report request from the near-real time RIC. Similarly to, but differently from FIG. 11, the E2 node may manage AI/ML models. In this case, the E2 node may have performance evaluation authority. Therefore, the E2 node may configure/instruct the terminal for performance measurement and reporting. The terminal may perform performance measurement and report a result of the performance measurement to the E2 node. Alternatively, the terminal may perform performance calculation and report a result of the performance calculation to the E2 node. Alternatively, the terminal may report an event derived based on a result of performance evaluation to the E2 node.

The E2 node may receive a performance measurement report from the terminal. Then, the E2 node may perform performance evaluation calculation. Alternatively, the E2 node may receive a result of performance evaluation calculation. Then, the E2 node may perform a subsequent operation such as AI/ML online training or model change based on the performance evaluation result. Alternatively, the E2 node may receive an event report from the terminal. Then, the E2 node may perform a subsequent operation such as AI/ML online training or model change based on the event report.

### (3) Performance Monitoring and Evaluation Method of the Terminal

The terminal may perform performance monitoring and evaluation. In this case, the terminal may trigger the performance monitoring and evaluation by transmitting a performance monitoring and evaluation request to the E2 node. Therefore, when the terminal's request is accepted in the network, the terminal may receive instructions for measurement and reporting for performance monitoring and evaluation by being configured signals and resources for performance measurement and evaluation from the E2 node as in the previous case. In the case of an AI/ML model located in the terminal, the terminal may perform performance monitoring and evaluation and directly make decisions such as model selection/change. The terminal may perform a performance evaluation calculation and report a result of the performance evaluation calculation to the network or report an event derived based on the result of the performance evaluation calculation, and the network may perform appropriate operations accordingly.

### Data Collection Instruction

During the data collection process for training and inference of the AI/ML model performed in the SMO, non-real time RIC, or near-real time RIC, the SMO or near-real time RIC may request collected data from the E2 node through the O1/E2 interface. In this case, the E2 node may instruct the terminal to report collected data through Ll signaling or higher layer signaling. Therefore, O1/E2 interfaces and the related information need to be reflected in the specifications.

### AI/ML Model Management

During the AI/ML model transfer and adaptation process, the near-real time RIC may select and retrieve an appropriate model from among several models in the model repository, and may select the appropriate model based on its generalization index. The generalization index may be derived based on performance values of the corresponding model produces in various scenarios and configurations.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a near-real time controller, comprising:
receiving, from a non-real time controller, information on an offline-trained artificial intelligence/machine learning (AI/ML) model;
obtaining, from a base station, first data for beam management inference based on the offline-trained AI/ML model;
performing beam management inference based on the offline-trained AI/ML model using the first data; and
providing a control and policy according to a result of performing the beam management inference to the base station.

2. The method according to claim 1, wherein the obtaining of the first data comprises:
requesting the first data for the beam management inference from the base station;
receiving a first signal including the first data from the base station; and
obtaining the first data from the first signal.

3. The method according to claim 1, further comprising:
obtaining, from the base station, second data for evaluating a performance of the beam management inference based on the offline-trained AI/ML model; and
evaluating the performance of the beam management inference base on the offline-trained AI/ML model using the second data.

4. The method according to claim 1, further comprising:
obtaining, from the base station, third data for online training of the offline-trained AI/ML model; and
performing online training of the offline-trained AI/ML model using the third data.

5. The method according to claim 1, wherein the providing of the control and policy comprises:
generating the control and policy according to the result of performing the beam management inference; and
providing the control and policy to the base station.

6. A method of a base station, comprising:
receiving a capability report request from a beam management device;
transmitting a capability report including capability information of the base station to the beam management device according to the capability report request;
receiving, from the beam management device, a transmission request for first data for offline training of an artificial intelligence/machine learning (AI/ML) model;
transmitting the first data to the beam management device according to the transmission request for the first data;
receiving information on a trained AI/ML model from the beam management device; and
performing beam management based on the trained AI/ML model.

7. The method according to claim 6, further comprising:
receiving, from the beam management device, a transmission request for second data for beam management inference based on the trained AI/ML model;
transmitting the second data for beam management inference to the beam management device; and
receiving, from the beam management device, a control and policy according to a result of the beam management inference using the second data,
wherein the base station performs the beam management according to the control and policy.

8. The method according to claim 6, further comprising:
receiving, from the beam management device, a control and policy for beam management inference using the trained AI/ML model;
collecting third data for the beam management inference; and
performing the beam management inference based on the AI/ML model using the third data, and
performing the beam management according to a result of the beam management inference.

9. The method according to claim 6, further comprising:
receiving, from the beam management device, a transmission request for fourth data for evaluating a performance of beam management inference based on the trained AI/ML model; and
transmitting the fourth data to the beam management device.

10. The method according to claim 6, further comprising:
collecting fifth data for evaluating a performance of beam management inference based on the trained AI/ML model; and
evaluating the performance of the beam management inference based on the trained AI/ML model using the collected fifth data.

11. The method according to claim 6, further comprising:
receiving a transmission request for sixth data for online training of the trained AI/ML model from the beam management device; and
transmitting the sixth data to the beam management device.

12. The method according to claim 6, further comprising:
collecting seventh data for online training of the trained AI/ML model; and
performing online training of the trained AI/ML model using the seventh data.

13. A base station comprising at least one processor, wherein the at least one processor causes the base station to perform:
receiving a capability report request from a beam management device;
transmitting a capability report including capability information of the base station to the beam management device according to the capability report request;
receiving, from the beam management device, a transmission request for first data for offline training of an artificial intelligence/machine learning (AI/ML) model;
transmitting the first data to the beam management device according to the transmission request for the first data;
receiving information on a trained AI/ML model from the beam management device; and
performing beam management based on the trained AI/ML model.

14. The beam management device according to claim 13, wherein the at least one processor further causes the base station to perform:
receiving, from the beam management device, a transmission request for second data for beam management inference based on the trained AI/ML model;
transmitting the second data for beam management inference to the beam management device; and
receiving, from the beam management device, a control and policy according to a result of the beam management inference using the second data,
wherein the base station performs the beam management according to the control and policy.

15. The beam management device according to claim 13, wherein the at least one processor further causes the base station to perform:
receiving, from the beam management device, a control and policy for beam management inference using the trained AI/ML model;
collecting third data for the beam management inference; and
performing the beam management inference based on the AI/ML model using the third data, and
performing the beam management according to a result of the beam management inference.

16. The beam management device according to claim 13, wherein the at least one processor further causes the base station to perform:
collecting fourth data for evaluating a performance of beam management inference based on the trained AI/ML model; and
evaluating the performance of the beam management inference based on the trained AI/ML model using the collected fourth data.

17. The beam management device according to claim 13, wherein the at least one processor further causes the base station to perform:
collecting fifth data for online training of the trained AI/ML model; and
performing online training of the trained AI/ML model using the fifth data.
